(19) United States
(12) Patent Application Publication
(10) Pub. No.: US 2011/0282731 A1
(43) Pub. Date: Nov. 17, 2011

(54) Systems and Methods for Optimizing Marketing Investments

(76) Inventors: Roland Guglielmi, Branford, CT (US); Henry Huang, Darien, CT (US); Joseph Milana, San Diego, CA (US); Drew Carter, St. Louis, MO (US)

(21) Appl. No.: 13/030,954

(22) Filed: Feb. 18, 2011

Related U.S. Application Data
(60) Provisional application No. 61/306,116, filed on Feb. 19, 2010.

(51) Int. Cl. G06Q 30/00

(52) U.S. Cl. 705/14.43

(57) ABSTRACT

Systems and methods for optimizing marketing investments are provided. The system includes a computer system in electronic communication with a business over a first communications link, means for electronically receiving marketing expenditure information from the business using the first communications link. The system executes an optimization algorithm which processes the marketing expenditure information and estimates at least one optimized future marketing expenditure for the business based upon the marketing expenditure information. the system electronically transmits the at least one optimized future marketing expenditure to a user using a second communications link, for subsequent display of the at least one optimized future marketing expenditure to the user.

### RELATED APPLICATIONS

This application claims the benefit of U.S. Provisional Application Ser. No. 61/306,116 filed Feb. 19, 2010, the entire disclosure of which is expressly incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the United States Patent and Trademark Office files or records, but otherwise reserves all copyright rights whatsoever.

### BACKGROUND OF THE INVENTION

1. Field of the Invention

This present invention relates generally to the field of marketing, and more specifically to systems and methods for optimizing marketing investments.

2. Related Art

In the current economy, money spent on marketing is extremely important for businesses. Many businesses wish to enhance the value that they receive out of each dollar they spend on acquiring new customers (e.g., by maximizing each marketing dollar spent by such businesses). Additionally, many businesses desire to improve the return on marketing dollars spent in terms of total new customers and/or accounts through a better allocation across and within various marketing channels including, for example: (a) understanding total contribution (including “halo,” as described below) for each channel; (b) understanding interaction between channels and products; and (c) defining performance drivers within each channel. Further, many businesses wish to achieve the goal of reducing marketing investment while still acquiring new customers.

What would be desirable are systems and methods which measure sales by businesses and which allow businesses to optimally distribute their marketing investments so as to maximize the return on investment (“ROI”) in marketing channels.

### SUMMARY OF THE INVENTION

The present invention relates to systems and methods for optimizing marketing investments. In one embodiment, the invention provides a system for optimizing marketing expenditures which includes a computer system in electronic communication with a business over a first communications link, means for electronically receiving marketing expenditure information from the business using the first communications link, an optimization algorithm executed by the computer system, said optimization algorithm processing the marketing expenditure information and estimating at least one optimized future marketing expenditure for the business based upon the marketing expenditure information, and means for electronically transmitting the at least one optimized future marketing expenditure to a user using a second communications link, for subsequent display of the at least one optimized future marketing expenditure to the user.

In another embodiment, the present invention relates to a method for optimizing marketing expenditures. The method includes the steps of electronically receiving at a computer system marketing expenditure information from a business, processing the marketing expenditure information at the computer system using an optimization algorithm to estimate at least one optimized future marketing expenditure for the business based upon the marketing expenditure information, and electronically transmitting the at least one optimized future marketing expenditure to a user for subsequent display of the at least one optimized future marketing expenditure to the user.

In another embodiment, the present invention relates to a computer-readable medium having computer-readable instructions stored thereon which, when executed by a computer system, cause the computer system to perform the steps of electronically receiving at the computer system marketing expenditure information from a business, processing the marketing expenditure information at the computer system using an optimization algorithm to estimate at least one optimized future marketing expenditure for the business based upon the marketing expenditure information, and electronically transmitting the at least one optimized future marketing expenditure to a user for subsequent display of the at least one optimized future marketing expenditure to the user.

### BRIEF DESCRIPTION OF THE DRAWINGS

Features of the invention will be apparent from the following descriptions of the Invention, taken in connection with the accompanying drawings, in which:

FIGS. 1-2 are flowcharts showing overall processing steps carried out by the system;

FIG. 3 is a graph comparing marketing investments to new account acquisitions by businesses;

FIGS. 4-5 are graphs illustrating scenario planning capabilities and budget optimization results capable of being generated by the system;

FIGS. 6A-6B are flowcharts showing processing steps carried out by the system for allowing a chief marketing officer (CMO) to view, manage, and optimize marketing expenditures for a business;

FIGS. 7A-7B are flowcharts showing processing steps carried out by the system for allowing a chief marketing manager (CMM) to view, manage, and optimize marketing expenditures for a business;

FIGS. 8A-8B are flowcharts showing processing steps carried out by the system for allowing product marketing manager (PMM) to view, manage, and optimize marketing expenditures for a business;

FIGS. 9-12 are diagrams showing sample data sets capable of being processed by the present invention to optimize marketing investments made by a business;

FIG. 13 is a diagram showing sample hardware and software components which could be utilized to implement the present invention; and

FIG. 14 is a diagram showing, in greater detail, sample hardware and software components of the optimization server shown in FIG. 13.

### DETAILED DESCRIPTION OF THE INVENTION

Described herein are systems and methods for optimizing marketing investments (occasionally referred to herein as a “Dashboard System” or simply “Dashboard”). The system monitors and stores information about current and past marketing expenditures made by businesses, processes the information to optimize future marketing expenditures to be made by such businesses, and gauges a client's marketing investment performance. The system allows users/clients to choose to view the performance of past marketing investments in number of ways, e.g., across an overall organization, within specific business groups, by marketing channels over a predetermined period of time (e.g., on a yearly, a quarterly, and/or a monthly basis), etc. The system automatically learns from past marketing investment performance to inform future marketing investment and allocation decisions by businesses. The system and methods described herein are designed to allow the user/client to optimize future expenditures in a number of ways, e.g., by maximizing sales (such as by optimizing maximum sales for a set advertisement budget) and/or by minimizing costs (such as by achieving a set sales target with minimum advertisement expenditure).

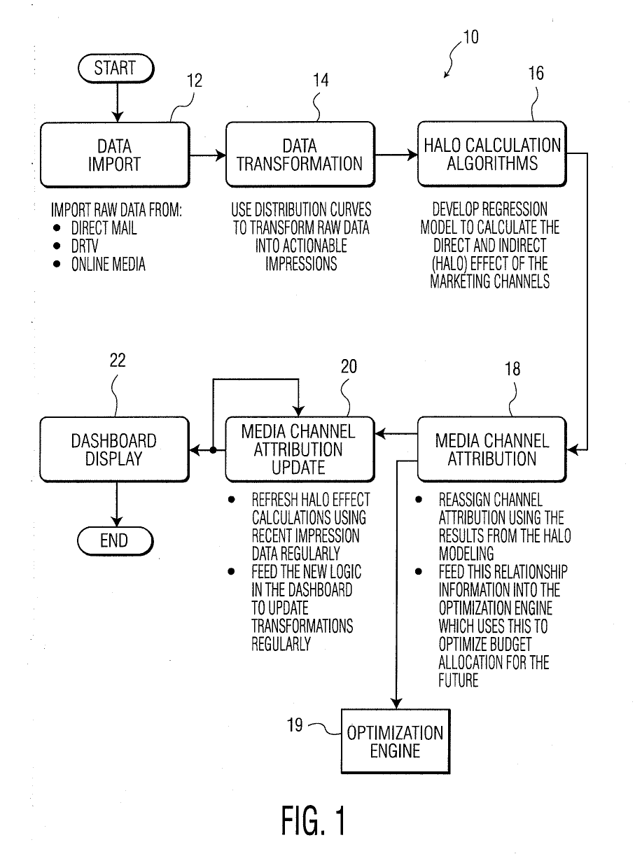

FIG. 1 is a flowchart showing overall processing steps carried out by the system, and indicated generally at 10. Beginning in step 12, the system performs a data import function, wherein data from a businesses' management information system(s) is electronically transmitted to, and/or imported by, the system for further processing. The data that can be processed by the system includes, but is not limited to, sales and marketing data from one or more marketing channels, investment and fulfillment information employed a business (including data related to new accounts acquired by the client's fulfillment channels over a period of time), data related to marketing investment channels employed by a business to reach audiences in the marketplace (e.g., impressions, “creatives,” and/or “dayparts”), etc.

In step 14, the raw data received from a business's management information system(s) in step 12 could optionally be processed (“cleaned”) so that the data is in a format suitable for processing by the system of the present invention (e.g., by removing outliers, converting data into the same unit, etc.). Cleaning could be performed, for example, by removing outliers and converting all the data into the same unit such as, for example, impressions, CPM, etc. Some of the data (such as information relating to direct mail and print advertising) may also need to be transformed to be a more realistic representative of when customers are actually exposed to the print and/or direct mail advertisements.

In step 16, the data is processed by one or more modeling algorithms (e.g., regression modeling or other suitable modeling algorithm) to calculate both the direct and indirect (halo) impact of each marketing channel of the business. In step 18, the results of modeling (e.g., the results of a halo calculation) are processed by the system to reattribute the account acquisition volume among the one or more marketing channels of the business, and the results are transmitted to an optimization engine 19 that is used to optimize marketing current and/or future marketing budget allocations across one or more channels to maximize business generation in the future. As discussed in greater detail below, the optimization engine 19 comprises computer-readable and executable software code which includes one or more optimization algorithms disclosed herein that perform the optimization functions of the present invention.

In step 20, the channel attribution logic of step 18 is updated on a predetermined basis such as, for example, on a quarterly basis, as new data becomes available. Further, a full model review could be conducted on, for example, a yearly basis. In step 20, the halo calculation(s) are refreshed using recent marketing impression data acquired by the system. On a yearly basis, for example, a system administrator could recommend a full model review of the halo models to confirm the relationships still hold true. New market dynamics and business environment may mandate a partial model refresh or a full model re-build. The system could include an alarm feature built in which alerts the user to the need for model refresh when the difference between the forecasted sales and actual sales crosses a set threshold. In step 22, a Dashboard user interface system is displayed to the user (e.g., on a screen of the user's local computing device, which could be a personal computer, cellular phone, smart phone etc.), allowing the user to view, manage, and/or project marketing expenses by a business.

It is noted that linear programming techniques could be utilized by the system to optimize a marketing investment by, for example, account volume generation, profitability, etc., under a variety of budgeting scenarios and business constraints. Users are able to modify fields (such as optimal budget allocation to a channel) and constraints (such as movement (maximum or minimum investment levels) allowed within the various investment channels, credit policy related to the client's overall organization, specific business unit, etc.).

One value of a media mix optimization tool such as the system of the present invention is an improved understanding of indirect/halo sales generated by a company's marketing channels, and the ability to feed this learning back into the system to better inform future marketing investment decisions. Marketing investment decisions at businesses are typically made in product group or business group “silos.” These groups measure only the direct effects of the marketing channels they employ since they usually have limited access to marketing data from other groups. Consequently, they do not accurately quantify the indirect effects of all marketing channels associated with a business. Businesses do not maintain an overall marketing investment measurement system, to measure sales that allows them to optimally distribute their marketing investment and to maximize the ROI of individual channels.

The system of the present invention could allow a user to choose to view the performance of past marketing investments in the overall organization or in business groups, by marketing channels, on a predetermined basis such as, for example, on a yearly, quarterly and monthly basis (“Marketing Media Mix” results). Further, the user can choose to view details for the overall organization, by marketing channels. The user can view overall budget allocation across all marketing channels. Further, the user can view overall sales generation by marketing channels, as well as view other metrics, such as cost per unit and profit per unit, for each marketing channel in the overall organization. The user can view details of the attribution for the overall organization such as, for example, direct versus total attribution for sales generated and cost per unit metrics.

It is also noted that the system allows a user to view details for each business unit, by marketing channels, as well as budget allocation across marketing channels for each business group. Further, the user can view sales generation by marketing channels in a specific business group, and/or other metrics including, for example, cost per unit and profit per unit, for each marketing channel in a specific business group. Moreover, the user can view details of the attribution for each business group such as, for example, direct versus. total attribution for sales generated and cost per unit metrics.

The optimization engine 19 can use the learning from past marketing investment performance to inform future marketing investment and allocation decisions. The system can allow the user to optimize for maximizing sales (e.g., obtaining maximum sales for a set budget of advertising expenditure) or minimize costs (e.g., achieving set sales target with minimum advertising expenditure). The system can allow the user to choose to modify current/future marketing investment budget allocations for the overall organization or for each business unit by marketing channels on a predetermined basis such as, for example, on a yearly, quarterly and monthly basis. Additionally, the user can modify current/future marketing investment budget allocations for the overall organization or for each business unit by marketing channels and by product type or by product.

An additional benefit of the system of the present invention is that a user can optimize the budget allocation for maximizing sales or maximizing profits given a fixed overall budget or fixed business unit budgets. Further, output from the optimization engine 19 can provide the user with optimal allocation of marketing budget across marketing channels by product type or by product. This optimized result includes details on sales generation and cost per unit corresponding to the optimal budget allocation. The optimization engine 19 further allows the user to override the optimal budget allocation and view the result of such changes on sales generation and cost per unit metrics.

The optimization engine 19 of the system of the present invention is flexible and can be customized in various ways by a user. For example, the optimization engine 19 can be customized to add client specific business and legal constraints. Further, the system can include a scenario planning tool where the user is able to determine the outcome of various budget scenarios while utilizing different constraints. The system's output display can include, for example, both the current allocation of budget and the optimized allocation of the same advertising expenditure dollars by marketing channels for the overall organization and for each business unit. The output includes expected sales generation for current budget allocation and optimized allocation for the overall organization and for each business unit. Moreover, the system can be customized to add client specific business and legal constraints.

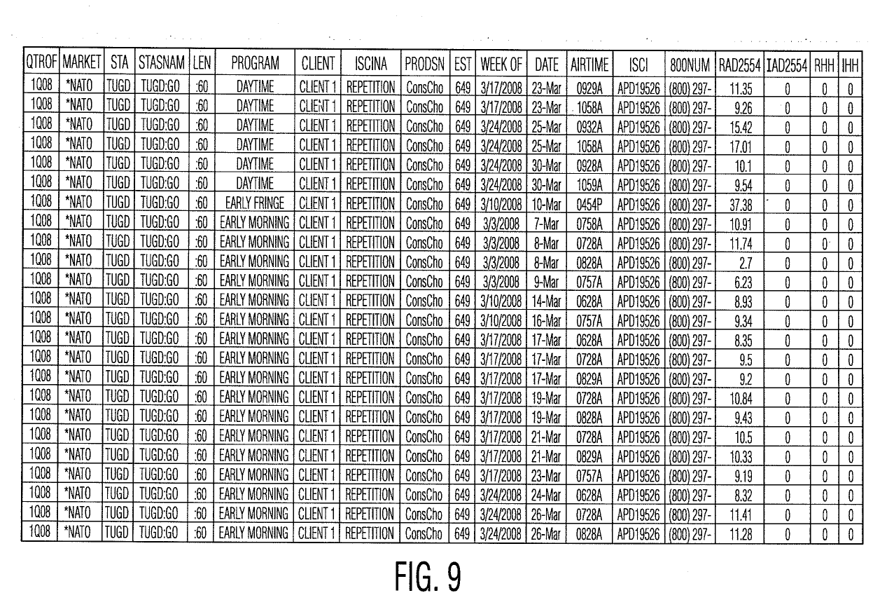

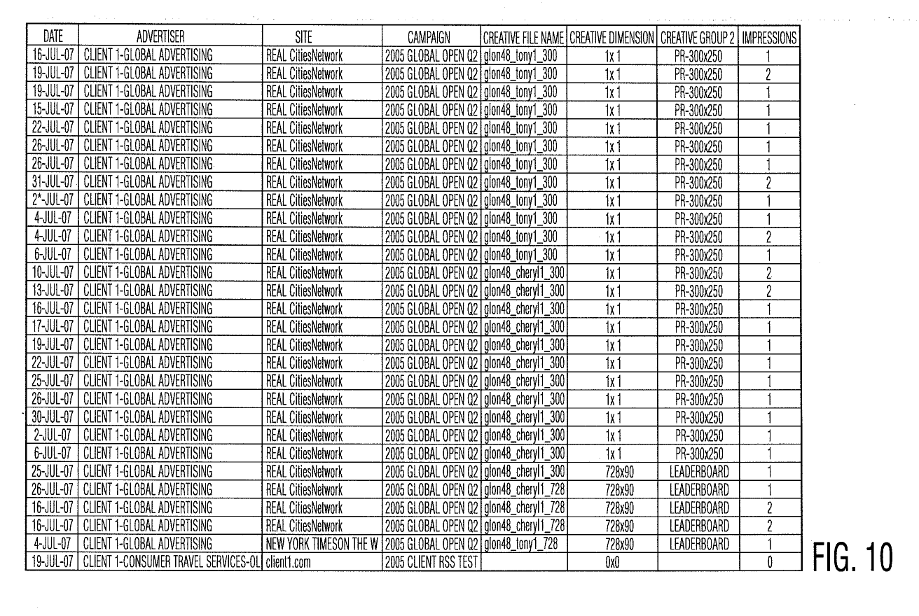

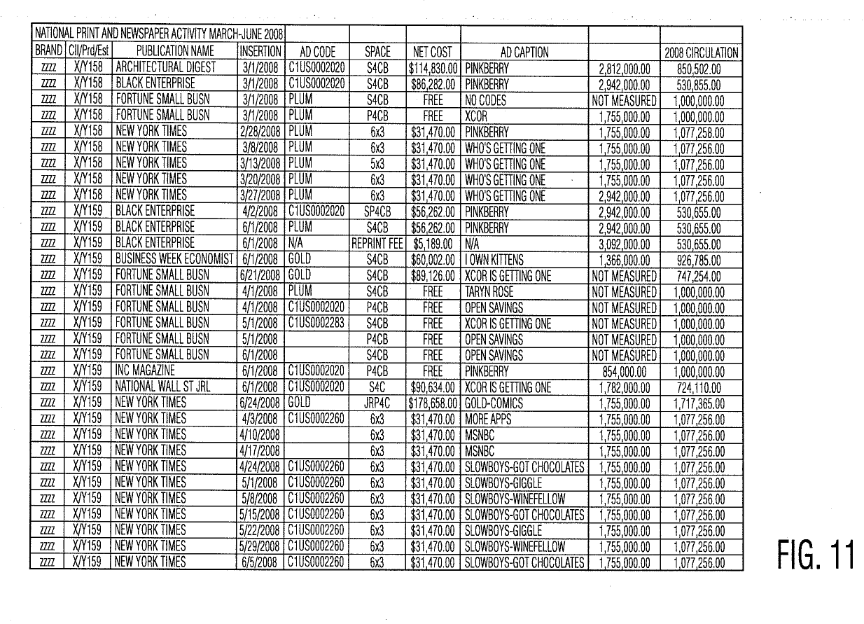

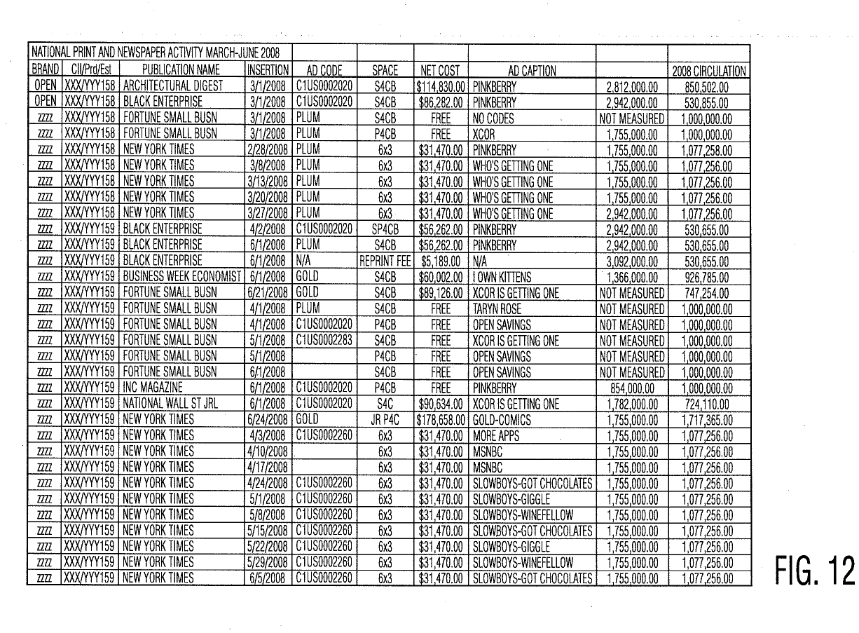

It is noted that, in step 12, sales and marketing data for all marketing channels utilized by a business can be collected. This includes data related to new accounts acquired by the client's fulfillment channels over the period of the study, and data related to marketing investment channels employed by the client to reach audiences in the marketplace, such as impressions, creatives, dayparts, etc. Sample datasets which can be collected in step 12 and processed by the system are shown in FIGS. 9-12. Such datasets could be obtained by the system of the present invention from one or more management information system(s) of a business, which could be in electronic communication with the system of the present invention via a network. As can be seen, the datasets could include information relating to television advertising (FIG. 9), display media (FIG. 10), and/or print media (FIGS. 11-12).

It is noted that a user can set up data feeds into a database of the system, if desired. The database could be updated regularly such as, for example, monthly or quarterly. However, the data itself could be daily-level information (e.g., quarterly updates would be adding historical daily data for the preceding quarter). This daily-level data, which may be in flat file format, could be converted to required standards before being stored in the database.

Advantageously, the system of the present invention can process certain data sets which may inaccessible to a client due to privacy regulations. For example, Internet cookie information (which is required for individual analysis of paid searches and advertising affiliates), is one such dataset. Relationship model information related to such datasets can be refreshed by the system during the full model re-build, or at other times.

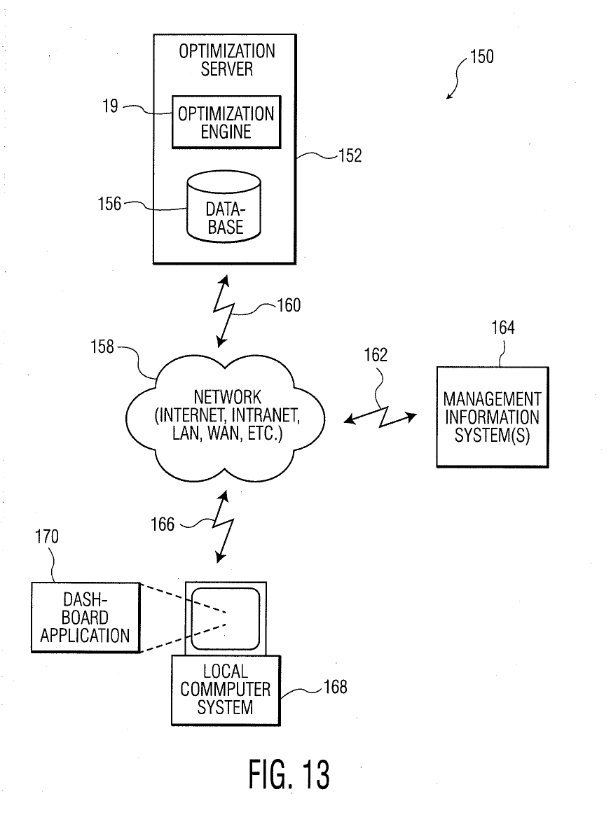

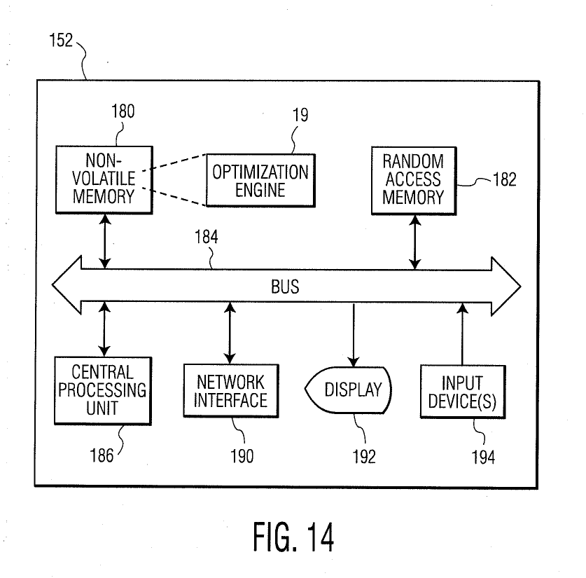

It is noted that the present invention could function inside the client's premises (i.e., on one or more computer systems operated in-house by the client), and within the firewall set up by the client's IT department. Of course, the invention could also operate in a client/server or web-based environment. Additional information relating to hardware/software components which could be utilized are discussed below in connection with FIGS. 13-14.

As mentioned above, linear programming techniques could be employed to optimize the marketing investment for account volume generation/profitability/etc., under a variety of budgeting scenarios and business constraints. A “View Media Mix Budget Allocation and Optimization” screen could be generated by the system and displayed on the user's local computer system, and could communicate with and use the optimization engine 19 as the back-end (e.g., remote) processor. Sample regression models and optimization engine parameters according to the present invention are shown in Tables 1 and 2, below.

TABLE 1

| Regression Models: | | Intercept | Coefficients |
|---|---|---|---|
| 32 | Direct TV: Portfolio I | = | 5.1 + 2.2 (IN_TV_GA) + 0 (IN_TV_GA_OP) + . . . + |
| Dependent | | | 1.94(IN_DM_OP_IN) |
| Variables | Direct TV: Portfolio II | = | 4.62 + 3.43(IN_TV_GA) + 4.62(IN_TV_GA_OP) + . . . + |
| | . | | 6.94(IN_DM_OP_IN) |
| | . | | . |
| | . | | . |
| | | | . |
| | Direct Mail: Portfolio | = | 111.53 + 0(IN_TV_GA) + 28.6(IN_TV_GA_OP) + . . . + |
| | III | | 0(IN_DM_OP_IN) |

TABLE 2
Objective: Maximize: Total Accounts or Total Profit, etc.
Engine

| | | 27 Independent Variables | | | |
|---|---|---|---|---|---|
| Decision Variables: | | IN_TV_GA | IN_TV_GA_OP | IN_RA_GA . . . | IN_DM_OP_IN |
| Constraints | Daily Impressions | 120.63 | 7.55 | 4.17 | 1.13 |
| | (millions) | | | | |
| | Minimum Annual | $25 | $2 | $0 | $5 |
| | Budget ($MM) | | | | |
| | Maximum Annual | $100 | $28 | $25 | $72 |
| | Budget ($MM) | | | | |
| | Total Budget | $500 | | | |
| | ($MM) | | | | |

The optimization engine 19 could include one or more objective functions tailored to a business's particular marketing needs/desires. In most cases, the client's objective primarily revolves around maximizing the acquisition of the most profitable products. Examples include maximizing total number of accounts generated, maximizing the total number of charge accounts generated, maximizing the total expected profit (for all new accounts acquired), minimizing the total marketing spend (while typically in conjunction with constraints maintaining a minimum number of new accounts or total profit acquired), maximizing the three (3) year metric of profit after tax not including the cost of acquisition, etc.

The decision variables utilized by the optimization engine 19 could also vary based upon a particular business's marketing needs/desires. For example, the results of the halo modeling exercise could form the primary feed into the decision variables section of the optimization engine 19, and the results could provide the relationship (expressed in the form of one or more mathematical equations) between the various media channels (which could be independent variables in the regression analysis) and the new account acquisition (which could be dependent variable in the regression exercise). An example of such an equation is provided below. The equation is a representation of the relationship between new account acquisition (daily level data) and the media investment (daily level impressions data):

γ=β0+β1 (television impressions)+β2 (direct mail impressions)+β3 (online impressions) Equation 1

The optimization “solver” or linear program of the optimization engine 19 changes the investment levels in the various channels within a given set of constraints in order to achieve the objective function results.

The constraints of the optimization engine 19 could also vary based upon a business' marketing desires/needs, and could comprise both business related and non-business constraints. Business constraints include, for example, conditions that the new investment level “advised” by the linear program employed in a specific channel cannot be 10% less than or greater than investment seen in the past year. This helps make the movement of spent dollars more gradual among the different channels employed, especially if the client is interested in a “test and learn” model for media mix optimization. Non-business constraints include, for example, conditions that the investment level cannot be negative or cannot be zero. Other constraints are of course possible.

The optimization engine 19 can also process other inputs. Such inputs include all other limitations/constraints related to the client's business such as, for example, the ratio of allocation of marketing budget among business units.

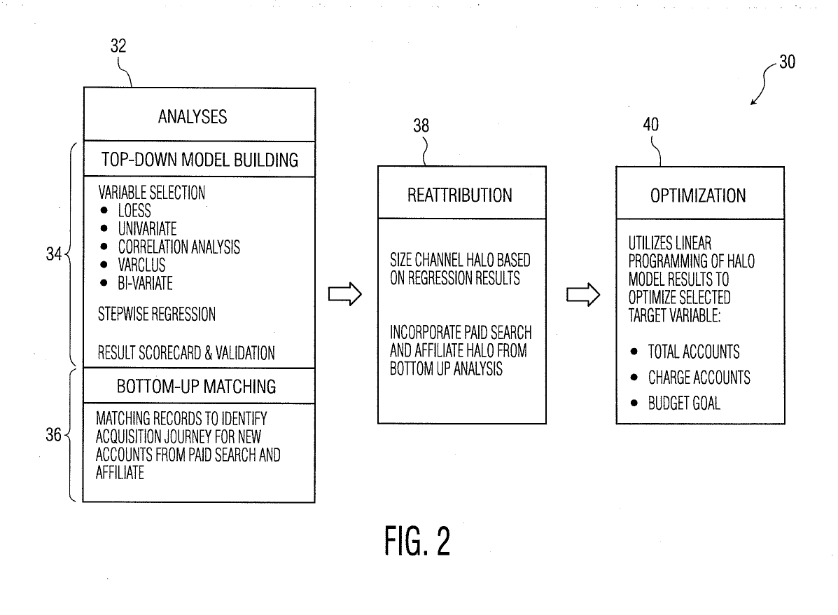

FIG. 2 is a flowchart showing overall processing steps carried out by the present invention, indicated generally at 30. The overall steps 30 can be described as a set of analysis procedures 32, followed by reattribution procedures 38, followed by optimization procedures 40. The analysis procedures 32 include top-down model building processes 34 and bottom-up matching processes 36. The top-down model building processes 34 include selection of values to be included in the modeling process (including, but not limited to, loss information, univariate information, correlation analysis information, varclus information, and bi-variate information). Additionally, the top-down model building processes 34 include stepwise regression analysis and result scorecard generation and validation. The bottom-up matching processes 36 match records to identify an acquisition “journey” for a new business account, from paid search and affiliate phases. Reattribution procedures 38 size the “halo” for a given channel based upon the regression results, and incorporate paid search and affiliate halo from the bottom-up matching processes 36. Optimization procedures 40 utilize linear programming of halo model results to optimize a selected target variable, which could include total accounts for a business, charge accounts for a business, or budget goals of a business.

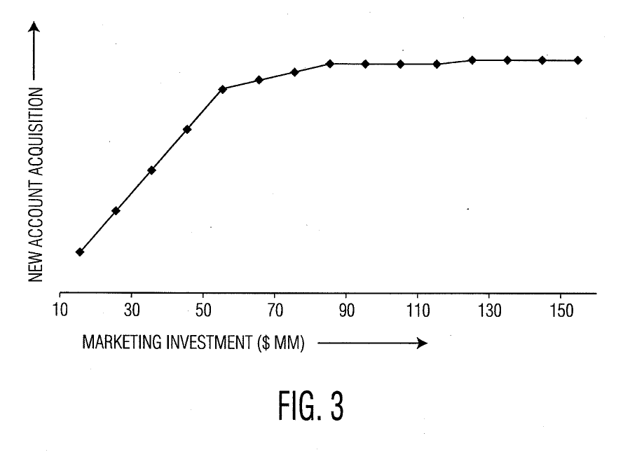

The overarching relationship between marketing investment and new account acquisition is non-linear. The system of the present invention could process these learned relationships to derive results from assuming an underlying linear relationship. For example, during a client engagement, management consultants work with typically twelve (12) to twenty-four (24) months worth of data. Consequently, the analysis is limited to generating insights related to the relationship between marketing spend and new account acquisition reliably exhibited in the data set over this historical period. The underlying assumption is that the relationship between spend and acquisition is linear along intervals of a scalability curve. For example, as shown in the diagram depicted in FIG. 3, the relationship is linear along a set of closely placed points. The relationship is linear from an investment level of $10 million (MM) to $50 mM and then from $50 mM to $90 mM. However it is a non-linear relationship from $10 mM to $90 mM. The optimization engine 19 of the system of the present invention is programmed to address these (non-linear) saturation effects.

The optimization engine 19 of the present invention employs linear programming based on the foregoing assumption. Therefore, the scenario planning function within the system is constrained by this assumption, and its results are reasonable within a specific range of investment and acquisition target. The scenario planning functionality allows the user to modify business conditions such as, for example, credit policy, variation in total budget allocated to the overall organization, business unit, and set of channels (within reasonable limits due to the linear programming constraints explained above) and to see the results of those actions on the acquisition results. This is also known as “scenario planning,” since the user is presented with different result “scenarios” depending on the set of constraints that is layered on top of the existing conditions that is already present in the server and optimization engine. Specifically, the user is able to modify fields, such as, for example, “optimal” budget allocation to the channel, and constraints such as, for example, movement (maximum or minimum investment levels) allowed within the various investment channels, credit policy related to the client's overall organization, or specific business unit.

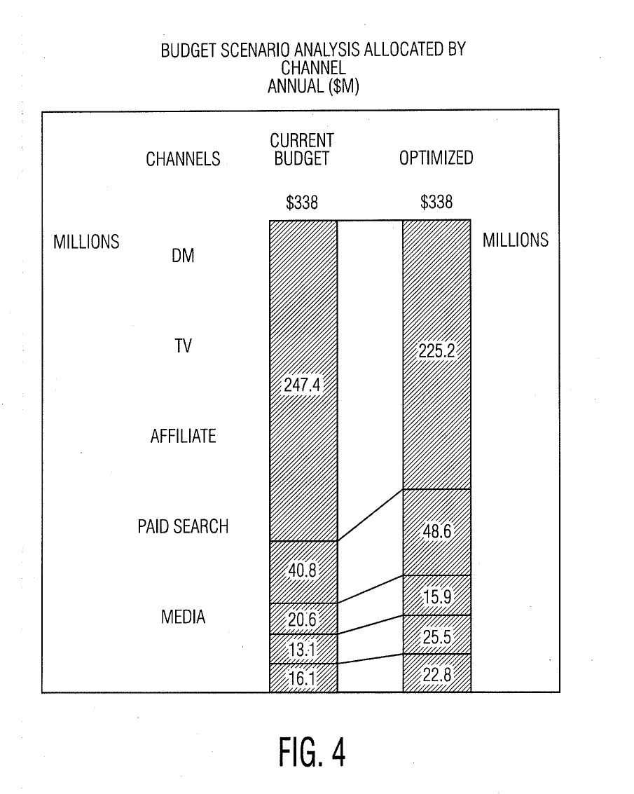

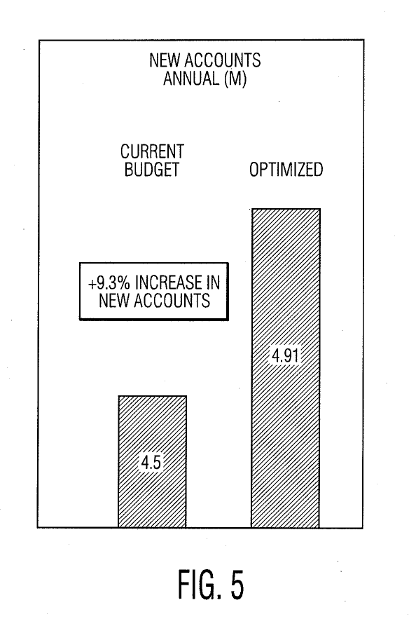

FIGS. 4-5 are graphs illustrating scenario planning capabilities and budget optimization results capable of being generated by the system of the present invention. FIG. 4 illustrates scenario planning for marketing budget allocation across the various channels employed by the client organization. For example, within a $338 million budget, allocation by channel undergoes optimization as shown in FIG. 4, and Table 3 below:

TABLE 3

| Channel | Current Budget | Optimized Budget |
|---|---|---|
| DM | 247.4 | 225.2 |
| TV | 40.8 | 48.6 |
| Affiliate | 20.6 | 15.9 |
| Paid Search | 13.1 | 25.5 |
| Media | 16.1 | 22.8 |
| | 338 | 338 |

FIG. 5 illustrates scenario planning for new accounts acquired if marketing budget is allocated optimally across the various channels employed by the client organization. As shown in FIG. 5, an approximate 9.3 percent increase in new customer accounts (from 4.5 million to 4.91 million) is realized using the optimization systems and methods described herein.

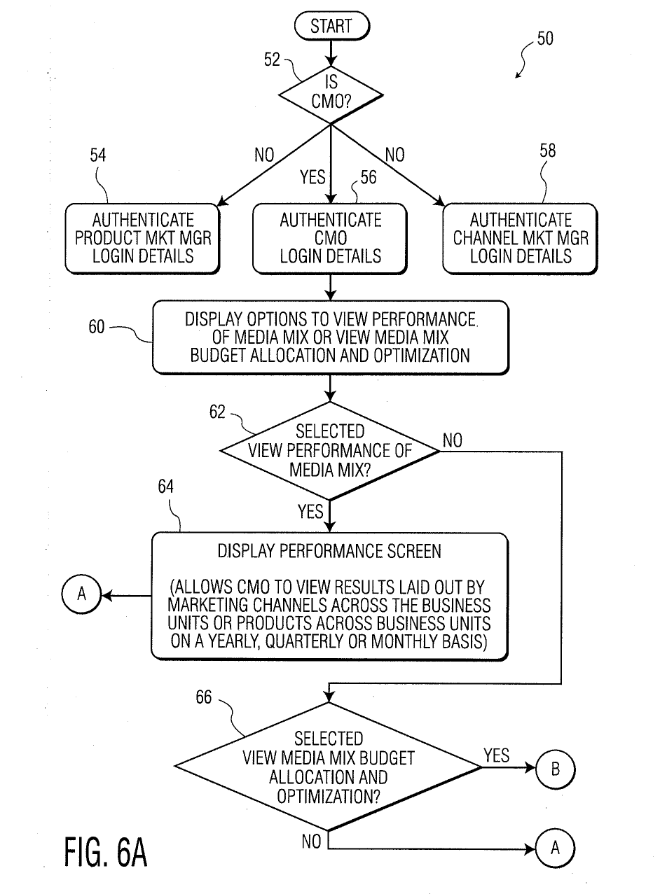

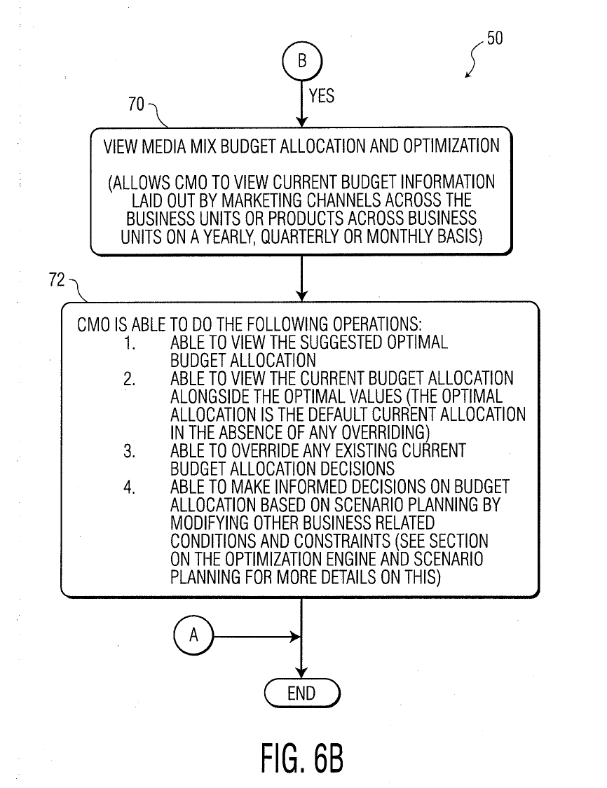

The system of the present invention can be used by a variety of users, including, but not limited to a Chief Marketing Office (“CMO”), a Channel Marketing Manager (“CMM”), a Product Marketing Manager (“PMM”), etc. Processing steps carried out by the present invention in connection with each of the foregoing users is now discussed in connection with FIGS. 6A-8B.

FIGS. 6A-6B are flowcharts showing processing steps 50 according to the present invention for allowing a CMO to view, manage, and optimize marketing expenditures for a business. The CMO can be considered the equivalent of a “super user” of the system of the present invention. The CMO is able to choose to view performance information laid out by marketing channels across the business units or by products across the business units on a periodic basis such as, for example, on a yearly, quarterly and monthly basis. Similarly, the CMO can also choose to view the optimization information laid out by marketing channels across the business units or by products across the business units on that basis such as, for example, a yearly, quarterly and monthly basis. This user has permissions to view and modify all information, and the ability to supersede any modifications made by other users.

In steps 52-60, the system permits logging in/authentication of the CMO. The system could display a pre-welcome screen with fields for logon information such as, for example, username and password. The user is able to log in to the system if his/her username and password exist in one or more databases of the system. In step 52, a determination is made as to whether the user is a CMO. If not, steps 54 or 58 occur, wherein authentication of a PMM or a CMM could occur. Otherwise, step 60 occurs.

In step 60, upon successful login, the user comes to the welcome screen which displays two options/paths—“View Performance of Media Mix” and “View Media Mix Budget Allocation and Optimization.” In step 62, a determination is made as to whether the user selected the “View Performance of Media Mix” option. If so, step 64 occurs, wherein the system displays past performance metrics details that are relevant to the user logged in. The View Performance screen displays past overall marketing budget allocation, overall sales and other relevant metrics such as cost per unit and profit per unit. The user is able to view details of the attribution for the overall organization such as, for example, direct vs. total attribution for sales generated and cost per unit metrics. The user is able to view these details by marketing channels across the business units or by products across the business units on a periodic basis such as, for example, on a yearly, quarterly and monthly basis.

In step 66, a determination is made as to whether the user selected the “View Media Mix Budget Allocation and Optimization” option. If so, step 70 occurs, wherein the system displays the current budget allocation details that are relevant to the user logged in. The View Budget Allocation screen displays current overall marketing budget allocation and other relevant metrics alongside the optimal marketing budget allocation. The user is able to view these details by marketing channels across the business units or by products across the business units on a periodic basis such as, for example, on a yearly, quarterly and monthly basis. The optimal marketing budget allocation is the default allocation in the absence of overriding.

In step 72, the CMO can perform a number of operations. For example, the user can view overall marketing budget allocation and other relevant metrics alongside the optimal marketing budget allocation. Also, the user is able to view these details by marketing channels across the business units or by products across the business units on a periodic basis such as, for example, on a yearly, quarterly and monthly basis. The user is able to override the optimal budget allocation and view the result of such changes on sales generation and cost per unit metrics. The user is able to modify fields such as “optimal” budget allocation to the channel and constraints such as movement (maximum or minimum investment levels) allowed within the various investment channels, credit policy related to the client's overall organization or specific business unit.

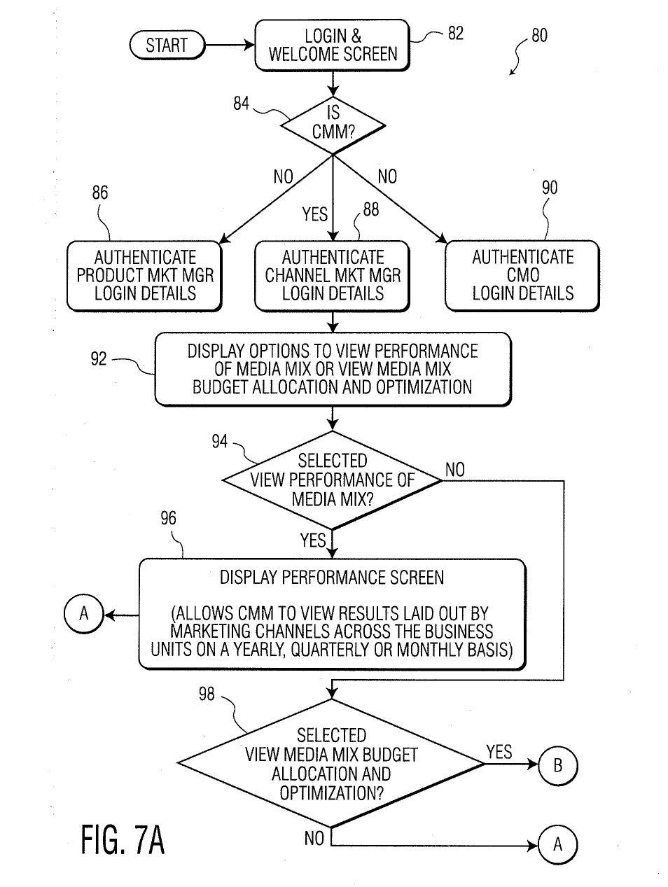

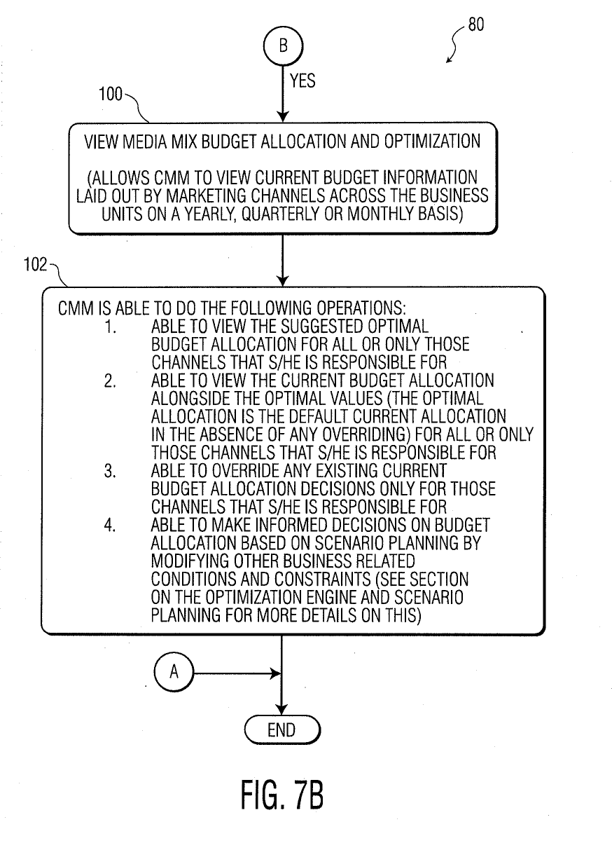

FIGS. 7A-7B are flowcharts showing processing steps 80 according to the present invention for allowing a CMM to view, manage, and optimize marketing expenditures for a business. The CMM, when logging in to the system, is shown performance information and optimization information laid out by marketing channels across the business units on a periodic basis such as, for example, on a yearly, quarterly and monthly basis. The CMM can be assigned various permission rights. For example, the CMM may be given read and write access to only those marketing channels that is relevant to his/her position and responsibilities within the client organization. Further, the CMM may be given read access to all channels but write access to only those marketing channels that are relevant to his/her position and responsibilities within the client organization.

In steps 82-90, the user is logged into the system/authenticated. In step 82, a pre-welcome screen is displayed by the system, with fields for login information such as, for example, username and password. The user is able to log in to the system if his/her username and password exist in one or more databases of the system. In step 84, a determination is made as to whether the user is a CMM. If not, steps 86 and/or 90 occur, wherein a PMM or a CMO could be authenticated. Otherwise, step 88 occurs, wherein the CMM is authenticated.

Upon successful login, in step 92, the user comes to the welcome screen which displays two options/paths—“View Performance of Media Mix” and “View Media Mix Budget Allocation and Optimization.” If, in step 94, the system determines that the user selected the “View Performance of Media Mix” option, step 96 occurs, wherein the system displays past overall marketing budget allocation, and/or overall sales and other relevant metrics such as cost per unit and profit per unit. The user is able to view details of the attribution for the overall organization such as, for example, direct vs. total attribution for sales generated and cost per unit metrics. The user is able to view these details by marketing channels across the business units on a periodic basis such as, for example, on a yearly, quarterly and monthly basis.

A determination is made in step 98 whether the user selected the “View Media Mix Budget Allocation and Optimization” option. If so, step 100 occurs, wherein a View Budget Allocation screen is displayed which includes the current overall marketing budget allocation and other relevant metrics alongside the optimal marketing budget allocation. The user is able to view these details by marketing channels across the business units on a periodic basis such as, for example, on a yearly, quarterly and monthly basis. The optimal marketing budget allocation is the default allocation in the absence of overriding.

In step 102, the user can perform a number of functions. For example, the user can modify the current budget allocation details that are relevant to the user logged in, and view current overall marketing budget allocation and other relevant metrics alongside the optimal marketing budget allocation. Further, the user is able to view these details by marketing channels across the business units on a periodic basis such as, for example, on a yearly, quarterly and monthly basis). The user is also able to override the optimal budget allocation and view the result of such changes on sales generation and cost per unit metrics. The user is further able to modify fields such as “optimal” budget allocation to the channel and constraints such as movement (maximum or minimum investment levels) allowed within the various investment channels, credit policy related to the client's overall organization and specific business unit (see section on the optimization engine and scenario planning for more details on this).

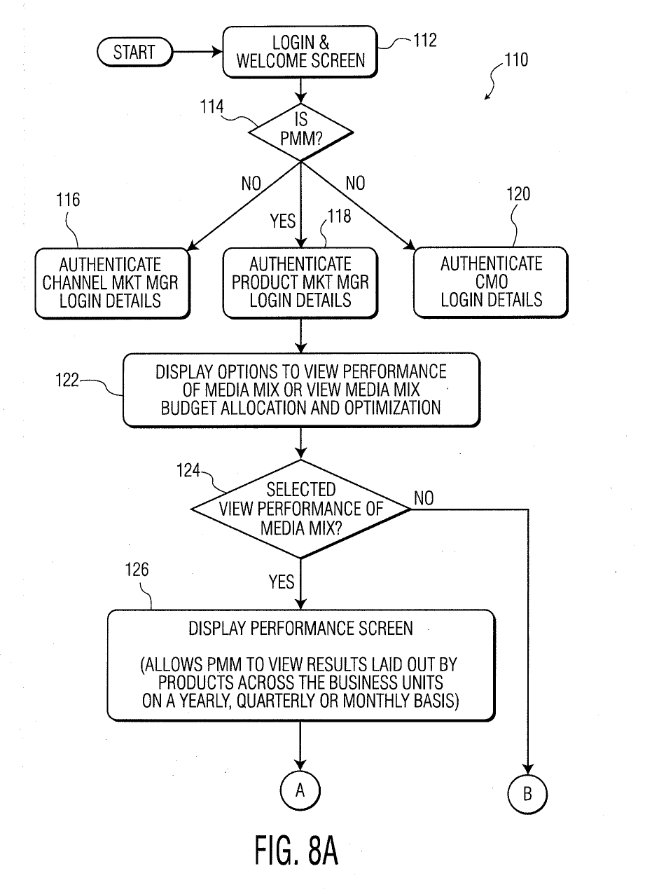

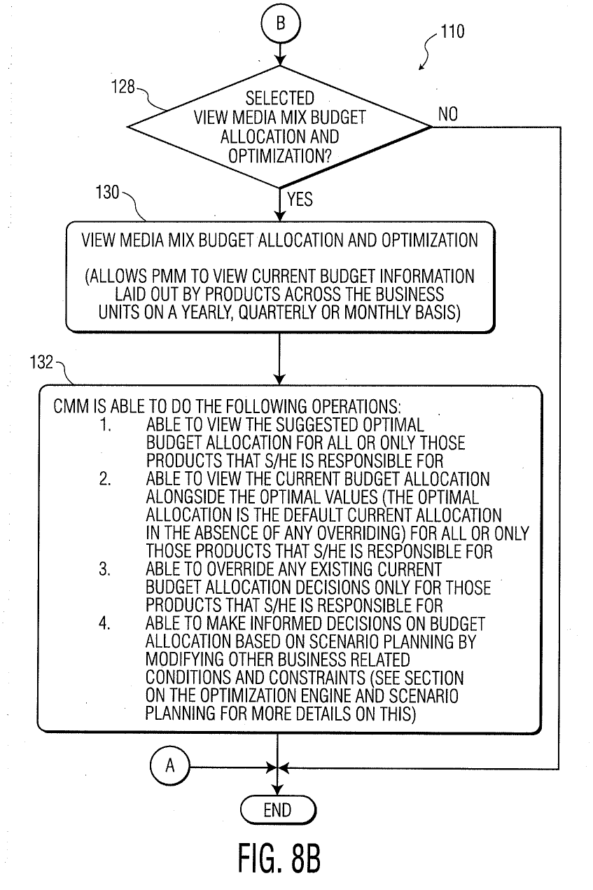

FIGS. 8A-8B are diagrams showing processing steps 110 according to the present invention for allowing a PMM to view, manage, and optimize marketing expenditures for a business. The PMM, when logging into the system, is shown performance information and optimization information laid out by products across the business units on a periodic basis such as, for example, on a yearly, quarterly and monthly basis. Various permission levels can be assigned to the PMM. For example, the PMM may be given read and write access to only those products that are relevant to his/her position and responsibilities within the client organization. The PMM may also be given read access to all products but write access to only those products that are relevant to his/her position and responsibilities within the client organization.

In steps 112-120, the PMM is logged into the system and authenticated. In step 112, a pre-welcome screen is displayed by the system, with fields for login information such as, for example, username and password. The user is able to log in to the system if his/her username and password exist in one or more databases of the system. In step 114, a determination is made as to whether the user is a PMM. If not, steps 116 and/or 120 occur, wherein a CMM or a CMO could be authenticated. Otherwise, step 122 occurs, wherein the PMM is authenticated.

Upon successful login, in step 122, the user comes to the welcome screen which displays two options/paths—“View Performance of Media Mix” and “View Media Mix Budget Allocation and Optimization.” If, in step 124, the system determines that the user selected the “View Performance of Media Mix” option, step 126 occurs, wherein the system displays past performance metrics details that are relevant to the user logged in. The View Performance screen displays past overall marketing budget allocation, overall sales and other relevant metrics such as cost per unit and profit per unit. The user is able to view details of the attribution for the overall organization such as, for example, direct versus total attribution for sales generated and cost per unit metrics. The user is able to view these details by products across the business units on a periodic basis such as, for example, on a yearly, quarterly and monthly basis.

A determination is made in step 128 whether the user selected the “View Media Mix Budget Allocation and Optimization” option. If so, step 130 occurs, wherein a View Budget Allocation screen is displayed which includes the current budget allocation details that are relevant to the user logged in. The View Budget Allocation screen displays current overall marketing budget allocation and other relevant metrics alongside the optimal marketing budget allocation. The user is able to view these details by products across the business units on a periodic basis such as, for example, on a yearly, quarterly and monthly basis. The optimal marketing budget allocation is the default allocation in the absence of overriding.

In step 130, the user can perform a number of functions. For example, the user can modify the current budget allocation details that are relevant to the user logged in, and view current overall marketing budget allocation and other relevant metrics alongside the optimal marketing budget allocation. Further, the user is able to view these details by products across the business units on a periodic basis such as, for example, on a yearly, quarterly and monthly basis. The user is also able to override the optimal budget allocation and view the result of such changes on sales generation and cost per unit metrics. Moreover, the user is able to modify fields such as “optimal” budget allocation to the channel and constraints such as movement (maximum or minimum investment levels) allowed within the various investment channels, credit policy related to the client's overall organization or specific business unit.

It is noted that the system of the present invention can process a number of metrics of interest to users, including, but not limited to: profit per unit, by products and by channels; cost per unit (based on direct and indirect attribution), by products and by channels; credit quality, by products and by channels; cost per media impression; conversion rate (number of impressions required to generate one sale); and/or impression headroom. Additionally, the optimization functions performed by the present invention could be tailored to optimize expenditure for the purpose of producing a particular objective within certain global constraints. For example, if the objective function discussed above is directed to a total number of new accounts, one or more global constraints could be applied to the objective function, such as: total budget, total number of accounts produced in a sub-portfolio of the issuer (e.g., a credit card company may spend marketing dollars to populate very distinct portfolios, while small business and individuals may have different spending needs/desires).

FIG. 13 is a diagram showing sample hardware and software components 150 which could be utilized to implement the present invention. The present invention could be implemented on an optimization computer system (server) 152, which includes the optimization engine 19 and one or more databases 156 associated therewith. The optimization engine 19 could be embodied as computer-readable and computer-executable software code which is stored in a computer readable medium associated with the server 152. The optimization engine 19 could be written in any suitable high- or low-level computing language, such as C, C++, Java, etc. The server 152 could support any suitable computer operating system (e.g., UNIX, Linux, etc.), and the database 156 could be supported by an suitable, commercially-available relational database management system (RDBMS), such as ORACLE, etc.

As shown in FIG. 13, the server 152 could communicate with one or more management information system(s) 164 of a business, via the network 158 and associated communications links 160 and 162. The network 158 could include the Internet, an intranet, a local area network (LAN), a wide area network (WAN), etc. It is noted that the optimization server 152 could be remote from the system(s) 164, or at the same location. Moreover, the system of the present invention (including the optimization engine 19 and the database 156) could be hosted entirely by the system(s) 164, in which case the present invention is hosted entirely within a business's IT infrastructure. The optimization server 152 obtains information from the system(s) 164 in the manner described hereinabove, for processing of such information and optimization of marketing investments by the business.

A user's local computer system 168 communicates with the optimization server 152 and/or the system(s) 164 via the network 158 and the communication links 166, 160, and/or 162. The dashboard application of the invention (shown in FIG. 13 as element 170) could execute on the local computer system 168, or it could be entirely web-based, in which case the functions of the present invention could be accessed using any conventional web browser. The local dashboard application 170 provides the user interface discussed hereinabove, and communicates with the optimization server 152 (and the optimization engine 19). Optimization information generated by the engine 19 could be transmitted to the dashboard application 170 of the user's local system 168, for access and use. It is noted that the local computer system 168 could be a server, a personal computer, a personal digital assistant (PDA), a cellular telephone, a smart phone (e.g., Apple iPhone, RIM Blackberry, etc.).

FIG. 14 is a diagram showing hardware and software components of the server 152 of FIG. 13 in greater detail. The server 152 could include a non-volatile memory 180 which stores the optimization engine 19, a random-access memory (RAM) 182, a bus 184, a central processing unit (CPU) 186, a network interface 190, a display 192, and one or more input devices 194. The non-volatile memory 180 could include read-only memory (ROM), erasable, programmable ROM (EPROM), electrically erasable, programmable ROM (EEPROM), flash memory, disk storage, etc. The RAM 182 could be any suitable type of RAM, such as dynamic RAM (DRAM), etc. The bus 184 permits communication within the server 152 of the various components shown in FIG. 14. The CPU 186 could include one or more microprocessor(s) each having one or more processing core(s), and conforming to any suitable architecture (e.g., Intel x86, Sun SPARC, etc.). The network interface 190 permits communication between the server 152 and the network 158 of FIG. 13, and could include any suitable wired or wireless network transceiver (e.g., Ethernet, Wi-Fi, etc.). The display 192 could include a flat-panel (LCD) display, touch screen, etc. The input device(s) 194 could include a keyboard, mouse, etc.

It should be understood that the present invention is not limited with regard to the variables used to optimize marketing investment. Accordingly, although the present invention has been described with reference to particular embodiments thereof, it is understood by one of ordinary skill in the art, upon a reading and understanding of the foregoing disclosure, that numerous variations and alterations to the disclosed embodiments will fall within the spirit and scope of the present invention and of the appended claims.

What is claimed is:

1. A system for optimizing marketing expenditures, comprising:
a computer system in electronic communication with a business over a first communications link;
means for electronically receiving marketing expenditure information from the business using the first communications link;
an optimization algorithm executed by the computer system, said optimization algorithm processing the marketing expenditure information and estimating at least one optimized future marketing expenditure for the business based upon the marketing expenditure information; and
means for electronically transmitting the at least one optimized future marketing expenditure to a user using a second communications link, for subsequent display of the at least one optimized future marketing expenditure to the user.

2. The system of claim 1, wherein the marketing expenditure information comprises existing marketing expenditure information corresponding to at least one marketing channel utilized by the business.

3. The system of claim 2, wherein the marketing expenditure information comprises existing marketing expenditure information corresponding to a plurality of marketing channels utilized by the business.

4. The system of claim 1, further comprising means for calculating a halo effect associated with an existing marketing channel of the business.

5. The system of claim 4, wherein the optimization algorithm processes the calculated halo effect.

6. The system of claim 1, further comprising means for reassigning marketing channel expenditures associated with the business.

7. The system of claim 6, wherein the optimization engine processes reassigned marketing channel expenditures.

8. The system of claim 6, wherein the means for reassigning marketing channel expenditures learns relationships between marketing expenditures across a plurality of marketing channels associated with the business.

9. The system of claim 1, wherein the computer system is in communication with at least one management information system associated with the business and electronically obtains the marketing information from the at least one management information system associated with the business.

10. The system of claim 1, further comprising means for displaying the at least one optimized future marketing expenditure on a local computing device operated by the user.

11. The system of claim 1, wherein the optimization algorithm estimates the at least one optimized future marketing expenditure within at least one global constraint.

12. A method for optimizing marketing expenditures, comprising the steps of:
electronically receiving at a computer system marketing expenditure information from a business;
processing the marketing expenditure information at the computer system using an optimization algorithm to estimate at least one optimized future marketing expenditure for the business based upon the marketing expenditure information; and
electronically transmitting the at least one optimized future marketing expenditure to a user for subsequent display of the at least one optimized future marketing expenditure to the user.

13. The method of claim 12, wherein the marketing expenditure information comprises existing marketing expenditure information corresponding to at least one marketing channel utilized by the business.

14. The method of claim 12, wherein the marketing information comprises existing marketing expenditure information corresponding to a plurality of marketing channels utilized by the business.

15. The method of claim 12, further comprising calculating a halo effect associated with an existing marketing channel of the business.

16. The method of claim 15, further comprising processing the calculated halo effect using the optimization algorithm.

17. The method of claim 12, further comprising reassigning marketing channel expenditures associated with the business.

18. The method of claim 17, further comprising processing the reassigned marketing channel expenditures using the optimization algorithm.

19. The method of claim 17, further comprising electronically learning relationships between marketing expenditures across a plurality of marketing channels associated with the business.

20. The method of claim 12, further comprising electronically obtaining at the computer system the marketing information from the at least one management information system associated with the business.

21. The method of claim 12, further comprising displaying the at least one optimized future marketing expenditure on a local computing device operated by the user.

22. The method of claim 12, further comprising estimating the at least one optimized future marketing expenditure within at least one global constraint.

23. A computer-readable medium having computer-readable instructions stored thereon which, when executed by a computer system, cause the computer system to perform the steps of:
electronically receiving at the computer system marketing expenditure information from a business;
processing the marketing expenditure information at the computer system using an optimization algorithm to estimate at least one optimized future marketing expenditure for the business based upon the marketing expenditure information; and
electronically transmitting the at least one optimized future marketing expenditure to a user for subsequent display of the at least one optimized future marketing expenditure to the user.

24. The computer-readable medium of claim 23, wherein the marketing expenditure information comprises existing marketing expenditure information corresponding to at least one marketing channel utilized by the business.

25. The computer-readable medium of claim 23, wherein the marketing information comprises existing marketing expenditure information corresponding to a plurality of marketing channels utilized by the business.

26. The computer-readable medium of claim 23, further comprising calculating a halo effect associated with an existing marketing channel of the business.

27. The computer-readable medium of claim 26, further comprising processing the calculated halo effect using the optimization algorithm.

28. The computer-readable medium of claim 23, further comprising reassigning marketing channel expenditures associated with the business.

29. The computer-readable medium of claim 28, further comprising processing the reassigned marketing channel expenditures using the optimization algorithm.

30. The computer-readable medium of claim 28, further comprising electronically learning relationships between marketing expenditures across a plurality of marketing channels associated with the business.

31. The computer-readable medium of claim 23, further comprising electronically obtaining at the computer system the marketing information from the at least one management information system associated with the business.

32. The computer-readable medium of claim 23, further comprising displaying the at least one optimized future marketing expenditure on a local computing device operated by the user.

33. The computer-readable medium of claim 23, further comprising estimating the at least one optimized future expenditure within at least one global constraint.
